(19) United States
(12) Patent Application Publication
(10) Pub. No.: US 2003/0078831 A1
(43) Pub. Date: Apr. 24, 2003

(54) System and method for supply chain modeling

(76) Inventors: Dorothea Kuettner, Mountain View, CA (US); Steve Kakouros, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/045,996

(22) Filed: Oct. 18, 2001

(51) Int. Cl. G06F 17/60

(52) U.S. Cl. 705/10; 705/8

(57) ABSTRACT

A development environment for supply chain management decision support systems. A framework is provided for the automatic generation of a supply chain model based upon input data concerning product demand and the parts and products that flow through activity centers such as factories, hubs, depots and the like. Parts source nodes, internal demand nodes, and terminal demand nodes are interconnected using an interactive symbolic visual interface that provides for the interconnection of nodes representing the activity centers to create a supply network scenario within the model. The supply network scenario may include more than one supply chain with each product having a unique supply chain. For each scenario, the statistical characteristics of part and product flow through the supply chain nodes is calculated within the model.

### BACKGROUND OF THE INVENTION

1. Field of the Invention

This invention relates to supply chain management. In particular, the invention relates to a method for alternative supply chain design analysis.

2. Related Art

There are many software packages in use for the tracking and control of manufacturing and inventory functions within the modern business enterprise. These packages range in size from small standalone applications to large enterprise resource planning (ERP) programs in which supply chain analysis and optimization functions are a subset of the overall functionality.

In most cases the software packages available today have a rigid structure and are poorly suited to customization. Since the available applications cannot be tailored to suit the user's needs, a user must either do without a specific capability, or acquire considerably more capabilities than they desire. In the first case, an application may be used that is low in cost and relatively easy to learn, but will lack one or more desired capabilities. In the second case a complex application that is capable of providing all of the required functions will also have a considerable number of functions that are not needed and the application as a whole will be expensive and difficult to learn. In either case, there is a poor cost/benefit ratio.

Thus, the need exists for a flexible software solution for supply chain analysis that enables customizable supply chain simulation. A further need exists for a solution that is user friendly and does not require an inordinate amount of training.

### SUMMARY OF THE INVENTION

Accordingly, it is an object of the present invention to provide a method for supply chain analysis that is flexible and user friendly. It is a further object of the present invention to provide a method for supply chain simulation that is adaptable, allowing the user to tailor the method to their needs. These and other objects and advantages of the present invention and others not specifically recited above will be described in more detail herein.

A development environment for supply chain management decision support systems is disclosed. A framework is provided for the automatic generation of a supply chain model based upon input data concerning product demand and the parts and products that flow through activity centers such as factories, hubs, depots and the like. Parts source nodes, internal demand nodes, and terminal demand nodes are interconnected using an interactive symbolic visual interface that provides for the interconnection of nodes representing the activity centers to create a supply network scenario within the model. The supply network scenario may include more than one supply chain with each product having a unique supply chain. Thus, the complete supply network comprises a set of interconnected nodes assigned to products. For each scenario, the statistical characteristics of part and product flow through the supply chain nodes and connections is calculated within the model.

In one embodiment of the present invention, a spreadsheet application having a macro programming capability is used in combination with a computer system to provide an environment for building a supply chain model and then using the model to design and execute alternative supply chain scenarios. The use of a common spreadsheet application as a foundation provides an initial degree of familiarity for users of the invention and takes advantage of the spreadsheet application's native capabilities. It is also cost effective as the users do not need any special software or configuration.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a computer system forming a part of a system in accordance with an embodiment of the present claimed invention.

FIG. 2 shows the hierarchy of the modules in the development environment in accordance with an embodiment of the present claimed invention.

FIG. 3 shows the basic node types and the objects that flow through them in the supply chain model in accordance with an embodiment of the present claimed invention..

FIG. 4A-4D show the the minimal set of data input tables associated with the supply chain model in accordance with an embodiment of the present claimed invention.

FIG. 5A-5B show the minimal set of data output tables associated with a supply chain model in accordance with an embodiment of the present claimed invention.

FIG. 6 shows the interactive symbolic visual interface used to construct a scenario in accordance with an embodiment of the present claimed invention.

FIG. 7 shows a flowchart for the process of using the interactive symbolic interface to build a scenario in accordance with an embodiment of the present claimed invention.

FIG. 8 shows a flowchart for the overall process of building a model and running a scenario in accordance with an embodiment of the present claimed invention.

### DETAILED DESCRIPTION OF THE INVENTION

In the following detailed description of the present invention, a system and method for supply chain modeling, numerous specific details are set forth in order to provide a thorough understanding of the present invention. However, it will be obvious to one skilled in the art that the present invention may be practiced without these specific details. In other instances well known methods, procedures, components, and circuits have not been described in detail so as not to unnecessarily obscure aspects of the present invention

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals a bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the disclosure of the present invention, terms such as “processing” or “computing” or “calculating” or “computing” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's registers or memories or other such information storage, transmission or display devices.

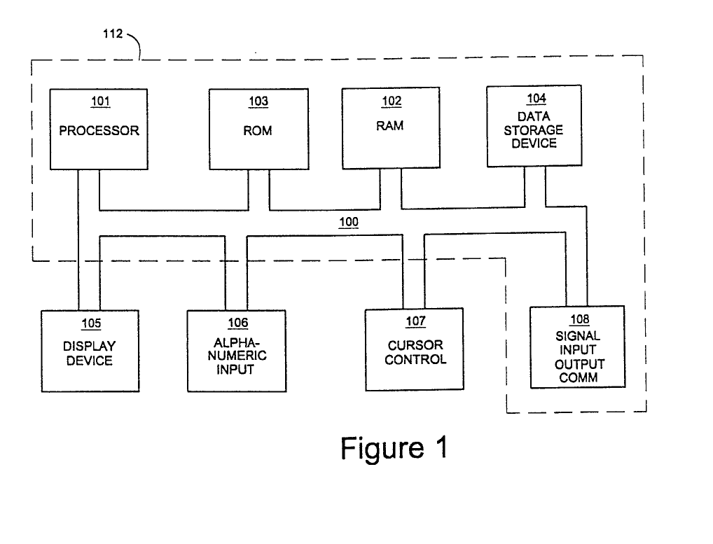

Refer to FIG. 1 which illustrates a computer system 112. In general, computer systems 112 used by the preferred embodiment of the present invention comprise a bus 100 for communicating information, a central processor 101 coupled with the bus for processing information and instructions, a random access memory 102 coupled with the bus 100 for storing information and instructions for the central processor 101, a read only memory 103 coupled with the bus 100 for storing static information and instructions for the processor 101, a data storage device 104 such as a magnetic or optical disk and disk drive coupled with the bus 100 for storing information and instructions, a display device 105 coupled to the bus 100 for displaying information to the computer user, an alphanumeric input device 106 including alphanumeric and function keys coupled to the bus 100 for communicating user input information and command selections to the central processor 101, cursor control device 107 coupled to the bus for communicating user input information and command selections to the central processor 101, and a signal generating device 108 coupled to the bus 100 for communicating command selections to the processor 101.

The display device 105 of FIG. 1 utilized with the computer system of the present invention may be a liquid crystal device, cathode ray tube or other display device suitable for creating graphic images and alphanumeric characters recognizable to the user. The cursor control device 107 allows the computer user to dynamically signal the two dimensional movement of a visible symbol (pointer) on a display screen of the display device 105. Many implementations of the cursor control device are known in the art including a trackball, mouse, joystick or special keys on the alphanumeric input device 105 capable of signaling movement of a given direction or manner of displacement. It is to be appreciated that the cursor means 107 also may be directed and/or activated via input from the keyboard using special keys and key sequence commands. Alternatively, the cursor may be directed and/or activated via input from a number of specially adapted cursor directing devices.

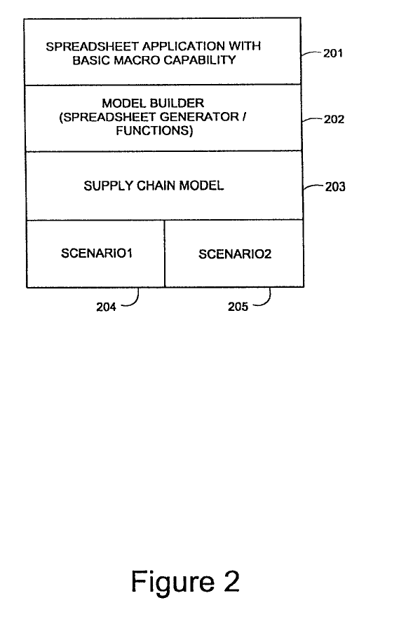

FIG. 2 shows the hierarchy of the modules in the development environment for one embodiment of the present invention. A spreadsheet application that has a macro programming capability 201 serves as the foundation. An example of such an application is MICROSOFT EXCEL, which has an extensive macro programming capability that utilizes MICROSOFT VISUAL BASIC. Using a spreadsheet application as a foundation for an application has certain advantages over the conventional approach of writing and compiling an application that runs under an operating system. Spreadsheet applications are ubiquitous, and an application that is designed to use the spreadsheet will be tend to be more familiar than a standalone application. Also, the native functions of the spreadsheet are readily available to the application, allowing the development effort to be focused on high-level concerns as opposed to basic mathematical and input/output functions. Although there are several commercially available spreadsheet applications that could serve as a foundation, a particular embodiment of the present invention will be described in the context of MICROSOFT EXCEL and MICROSOFT VISUAL BASIC.

The Model Builder 202 shown in FIG. 2 is a three-part framework that rests upon the MICROSOFT EXCEL spreadsheet application. The first part is a framework that automatically generates a spreadsheet model that is equipped with data input tables and output tables. The second part of Model Builder is a set of functions that access the data in the tables and perform calculations. The third part is the visual functionality that is provided to the spreadsheet model

The data structures used by the Model Builder use a specific capability of VISUAL BASIC to represent matrices as vectors of vectors. For example, a three-dimensional matrix in the conventional format of a matrix M(Pr,FromNode,ToNode) representing the product flow (Pr) from a first node (FromNode) to a second node (ToNode) can be represented in VISUAL BASIC as M(Pr) (FromNode,ToNode). This structure is useful in that the entire product flow matrix for a particular product can be obtained by a reference to a single element of the vector M(Pr). This data structure design provides flexibility for reporting and analysing the data in many dimensions.

The list of 11 functions shown below are MICROSOFT VISUAL BASIC macros that are available to the user. The last two functions are macro shells that are intended for user developed macro code.

1. ProductsActivitiesAndStDevs

SYNTAX:

ProductsActivitiesAndStDevs (SelectedScenario as Worksheet, Optional CM)

INPUTS:

SelectedScenario: The worksheet corresponding to the running scenario.

CM: Optional Array containing the scenario connectivity matrix.

OUTPUT:

Array (2) (TerminalDemandNodes+InternalDemandNodes, Products)

USE:

To calculate propagated demand for products in all nodes.

Array(1) contains the mean and. Array(2) contains the standard deviation

2. NodeToNodeFlows

SYNTAX:

NodeToNodeFlows (SelectedScenario as Worksheet, Optional CM, Optional ProductActivities)

INPUTS:

SelectedScenario: The worksheet corresponding to the running scenario.

CM: Optional Array containing the scenario connectivity matrix.

ProductActivities: Optional Array containing the propagated demand for products in all nodes

OUTPUT:

Array(Products)(TerminalDemandNodes+InternalDemandNodes, TerminalDemandNodes+InternalDemandNodes)

USE:

To calculate flow of products from all nodes to all nodes. Array(Products) contains all the flows in the network for the specific product.

3. NodeToProductTransitTimes

SYNTAX:

NodeToProductTransitTimes (SelectedScenario as Worksheet, Optional CM,)

INPUTS:

SelectedScenario: The worksheet corresponding to the running scenario.

CM: Optional Array containing the scenario connectivity matrix.

OUTPUT:

Array (2) (TerminalDemandNodes+InternalDemandNodes, Products)

USE:

To calculate the transit times to get products into all nodes. Array(1) contains the mean transit times and Array(2) contains the standard deviation of transit times

4. IsFactory

SYNTAX:

IsFactory (Node, PR, Optional CM)

INPUTS:

Node: An integer corresponding to a node in the model. Nodes are numbered in the same sequence they were entered in MB's Design Page. The number must be less than or equal to(TerminalDemandNodes+InternalDemandNodes)).

Pr: An integer corresponding to a product in the model.

Products are numbered in the same sequence they were entered in the Model Builder's Design Page. The number must be less than or equal to Products.

OUTPUT:

Boolean

USE:

To investigate if the node is a manufacturing node (At the top of the supply chain) for the specific product.

5. TransformationActivities

SYNTAX:

TransformationActivities(SelectedScenario as Worksheet, Optional CM, Optional ProductActivities)

INPUTS:

SelectedScenario: The worksheet corresponding to the running Scenario.

CM: Optional Array containing the scenario connectivity matrix.

ProductActivities: Optional Array containing the propagated demand for products in all nodes

OUTPUT:

Array(FromForm, ToForm)

(TerminalDemandNodes+InternalDemandNodes,Products)

USE:

To calculate the volumes of all product transformations taking place in all nodes in the network for all products. The number of all possible transformations is equal to two times the number of possible ProductForms plus two. The additional two transformations come from the implied initial zero-form state of the product when we assume that it exists only as parts. The FromForm,ToForm indices take values from 0 to the number of possible ProductForms.

6. ProductsAndPartsActivities

SYNTAX:

ProductsAndPartsActivities (SelectedScenario as Worksheet, Optional CM, Optional ProductActivities)

INPUTS:

SelectedScenario: The worksheet corresponding to the running scenario.

CM: Optional Array containing the scenario connectivity matrix.

ProductActivities: Optional Array containing the propagated demand for products in all nodes

OUTPUT:

Array(2)(TerminalDemandNodes+InternalDemandNodes, Products+parts)

USE:

To calculate propagated demand for products in all nodes adjusted accordingly if a transformation took place and to calculate the resulting part demand as necessitated from the Bill of Materials. Array(1) contains the mean and Array(2) contains the SD.

7. GetTransitSplits

SYNTAX:

GetTransitSplits( )

INPUTS:

None.

OUTPUT:

Array (Products) (InternalDemandNodes, TerminalDemandNodes+InternalDemandNodes,1..3)

USE:

To get the transit flow fraction per transit mode: 1=Sea, 2=Ground, 3=Air.

8. PartFlows

SYNTAX:

PartFlows (SelectedScenario as Worksheet, Optional CM, Optional ProductActivities)

INPUTS:

SelectedScenario: The worksheet corresponding to the running scenario.

CM: Optional Array containing the scenario connectivity matrix.

ProductActivi ties: Optional Array containing the propagated demand for products in all nodes

OUTPUT:

Array(PartsNodes,

TerminalDemandNodes+InternalDemandNodes,Parts)

USE:

To calculate the flows for all parts from all suppliers to all nodes.

9. PartTransitTimes

SYNTAX:

PartTransitTimes (SelectedScenario as Worksheet, Optional CM, Optional ProductActivities)

INPUTS:

SelectedScenario: The worksheet corresponding to the running scenario.

CM: Optional Array containing the scenario connectivity matrix.

ProductActivities: Optional Array containing the propagated demand for products in all nodes

OUTPUT:

Array(2)(TerminalDemandNodes+InternalDemandNodes,Parts)

USE:

To calculate the transit time mean and SD for all parts at all nodes.

10. RunOneArc

SYNTAX:

RunOneArc (FromNode, ToNode))

INPUTS:

FromNode, ToNode: Integers corresponding to valid nodes as sequenced in the initial model design.

OUTPUT: User determined

USE:

Available subroutine for performing custom calculations for a specific connection.

11. RunOneNode

SYNTAX:

RunOneNode(Node))

INPUTS:

Node: Integer corresponding to valid node as sequenced in the initial model design.

OUTPUT: User determined

USE:

Available subroutine for performing custom calculations for a specific node.

The supply chain model 203 is produced by the Model Builder 202 on the basis of the initial input of names for supply chain elements entered on the Model Builder design page. The supply chain model 203 has two parts, a system part 203A and an optional user generated part 203B. The user generated part 203B accepts further input from the user (e.g. functions or calculations)that is used to create one or more scenarios such as scenariol 204 and scenario2 205. A scenario provides a visual representation of the actual supply chain, showing the nodes and their interconnections.

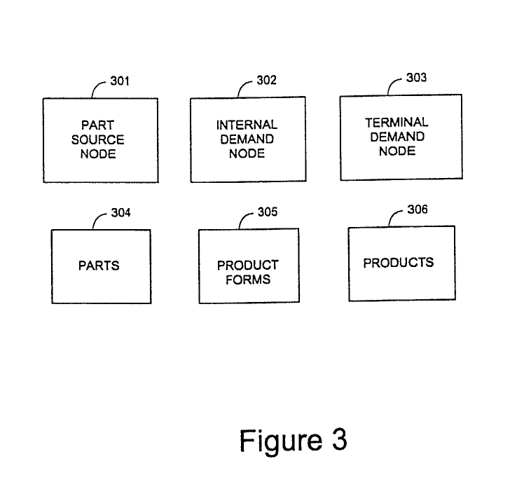

As shown in FIG. 3, there are six elements for building a model. The three types of nodes used in the model are parts source node 301, internal demand node 302, terminal demand 303. Also as shown in FIG. 3, there are three types of objects that move between nodes: parts 304, product forms 305 and products 306. Names for these six objects are provided to the Model Builder 202 as required.

A terminal demand node 303 is a “sink” for a finished product, i.e. and may represent a warehouse or an end user. A terminal demand 303 node accepts objects from other nodes in the supply chain, but only faces demand from outside the supply chain. Products 306 and parts 304 may flow into a terminal demand node 303, but they do not flow from a terminal demand 303 node into another node in the model.

The second type of node is an internal demand node 302. An internal demand node 302 represents a center of activity such as a depot or factory, where parts, product forms and products may flow in and out. Internal demand nodes may face demand from each other, and from terminal demand nodes.

The third type of node is a parts source node 301. A parts source node represents suppliers of the parts that make up the input to the supply chain. The “source” and “sink” characteristics of the parts source nodes and the terminal demand nodes establish these two types of nodes as boundary nodes for the model.

Parts 304 may be considered as the “atomic” input to the model. Both product forms 305 and products 306 are composed of parts. Parts 304 and product forms 305 are combined at the activity centers represented by the internal demand nodes. Activities include manufacturing, packaging and stocking.

The Model Builder 202 has a design page in the spreadsheet that includes a table in which the names are entered for the three types of model nodes and the three types of objects. The node and object names must be distinct. Once the names have been entered into the table, the user selects the ranges containing the names and the “Build Model” function is selected. The Model Builder uses the names provided to create data input tables. The enumeration and naming of the six elements of the supply chain model enables the Model Builder to establish a variable space into which data can be input.

Once the model is constructed, the user is presented with a series of input tables that correspond to the variable space. These tables are required for the minimal operation of the model. The user may add additional tables for input and output.

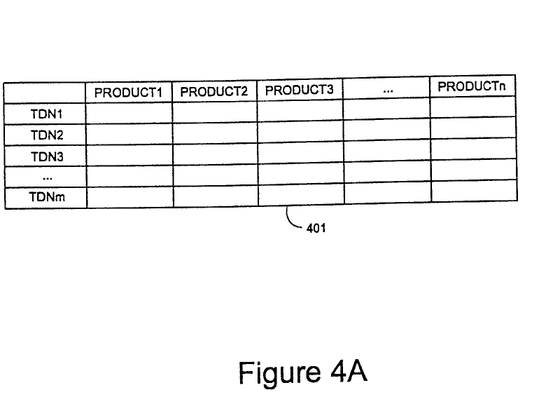

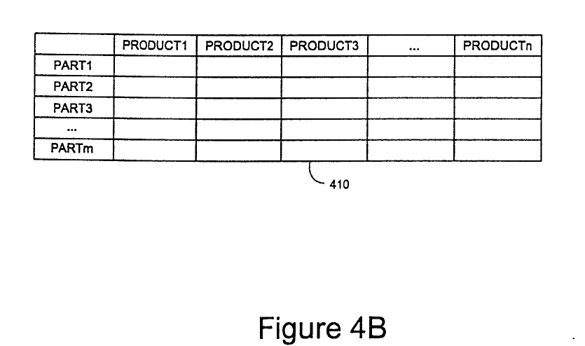

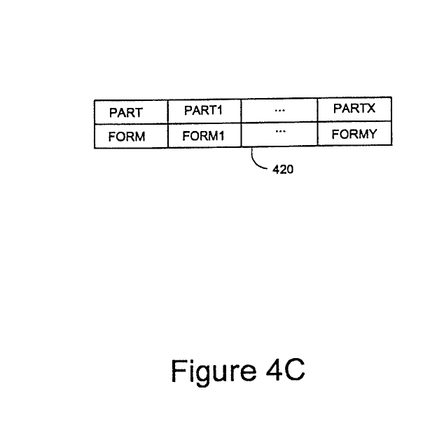

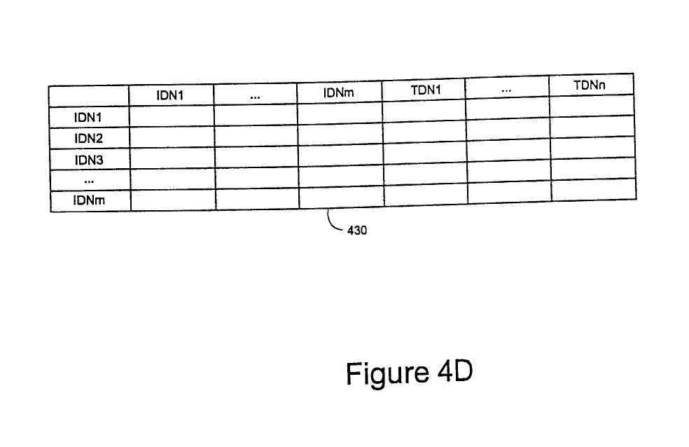

FIG. 4A shows the demand table format 401 of the Mean Demand Table (Terminal Demand Nodes×Products) and the Standard Deviation Table (Terminal Demand Nodes×Products). In each of these tables, the user enters the mean or standard deviation of the demand for each product at each Terminal Demand Node. These values correspond to a boundary condition for the supply chain model. It is assumed that the demand data is normally distributed with a mean and a standard deviation.

FIG. 4B shows a Bill of Materials table (BOM) for parts (Parts×Products) 410. The required number of parts for each product is entered into this table. The BOM table allows the product demand to be translated into a parts demand.

FIG. 4C shows a Bill of Materials for product forms (Parts×1) 420. This table is used to track the product forms or intermediate assemblies of products. A part transforms a product from one form to another, thus a part is associated with the Product Form that results from its incorporation.

FIG. 4D shows the format for an internode transit time table 430 that is required by the Model Builder. The data input into the table consists of the statistical data associated with the transit time between nodes. The transit time data itself consists of the values of the mean and standard deviation for the transit time by air, ground and sea. The column labels have both Internal Demand Nodes and Terminal Demand Nodes, since both are capable of receiving objects; however, the rows are only labeled with Internal Demand Nodes since objects cannot flow from a Terminal Demand Node. It is assumed that the transit time data is normally distributed with a mean and a standard deviation. In addition to the required tables, an optional ICE table may be used for inventory purposes. This table accepts the delivery frequency, review period and service level for each Terminal Demand Node and each Internal Demand Node. This is an example of user developed functionality.

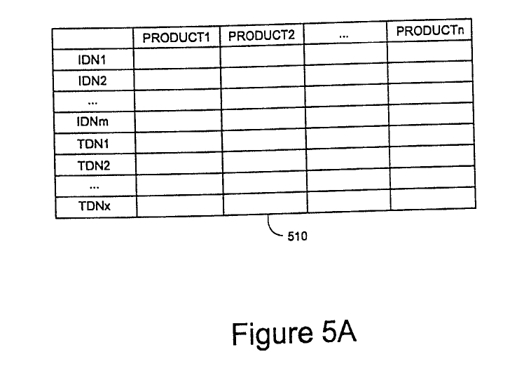

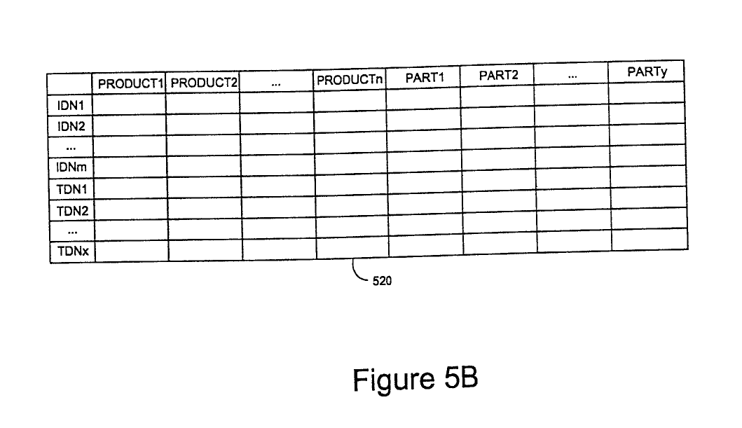

FIG. 5A shows the format of the Propagated Product Demand table ((Terminal Demand Nodes+Internal Demand Nodes)×Products) 510. There is one table for the mean and one table for the standard deviation.

FIG. 5B shows the format of the Resulting Product and Part Demand table ((Terminal Demand Nodes+Internal Demand) Nodes×(Products+Parts)) 520. The Resulting Product Demand table incorporates the product demand, and the part demand, as determined by the BOM tables.

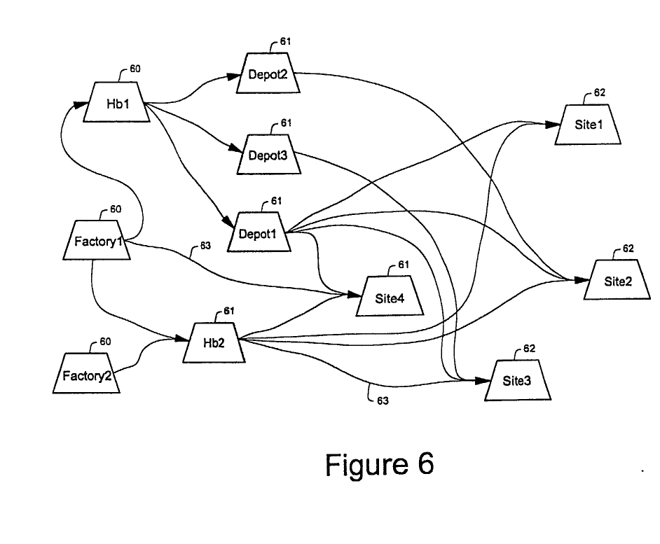

FIG. 6 shows the interactive symbolic visual interface that is used to construct and display a supply chain scenario. A supply chain scenario is a visual representation of a supply chain network that is produced by interconnecting the model nodes and defining the characteristics of the interconnections and assigning the set of visual elements to product(s). In FIG. 6, the trapezoids represent the Parts Source Nodes 60, the Internal Demand Nodes 61 and the Terminal Demand Nodes 62. The flexible arrows represent the connections between the nodes. The object flow between the nodes is in the direction of the arrows (or interactive connection elements), with the object flowing from the supplying node (FromNode) to the node that is supplied (ToNode).

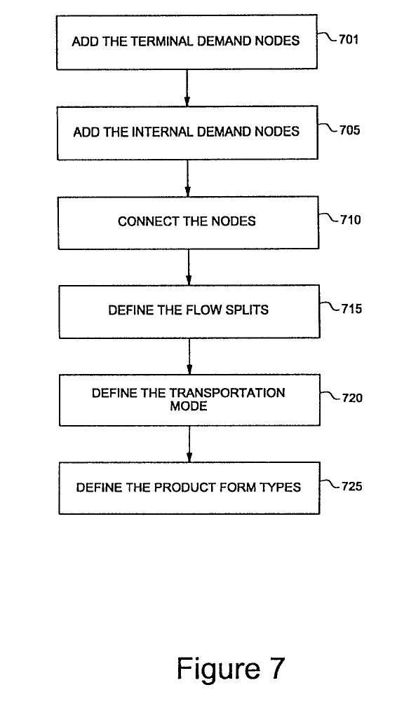

The interactive symbolic visual interface as shown in FIG. 6 is used to create a scenario by following the sequence of steps shown in FIG. 7. First, in step 701, the Terminal Demand Nodes are added by applying the AddTerminalDemandNode function to produce an interactive node icon on the display that is associated with a node for which data was previously entered in the model. Next, in step 705, the Internal Demand Nodes are added by calling the AddInternalNodes function. Again, an interactive node icon is placed on the display area representing a node from the model data set.

After the nodes for the scenario have been placed in the display area in step 710 the connections are made by using a visual display pointing device such as a mouse or trackball to select the nodes to be joined and to pull up a menu for selecting the connection parameters.

Every scenario is described in a structure named Connectivity Matrix.(CM). If a connection (I,J) exists the CM_{I,J} element is non-zero and it holds the flow split to node J. The general structure of the matrix is CM(2)(P)(FromNodes,ToNodes). Matrix CM(1) contains the flows and CM(2) contains the flow types for the supply chain of Product P;. The function that generates this structure is named SCConnectivityMatrix( ). The only nodes that have non-zero diagonal elements are the Terminal Demand Nodes. So, if I is a Terminal Demand Node for product P, then CM(1) (P) (I,I)=1.

In the final three steps, the Flow Split, Transportation Mode and Product Form are specified. In step 715, the Flow Split is specified. The Flow Split indicates the fraction of the ToNode demand that the FromNode supplies. In step 720, the Transportation mode is specified. The Transportation Mode has a default value of air shipment unless a specific fraction is entered for either ground or sea shipment, in which case the remaining fraction will be presumed to be air shipment. In step 725, the product forms are specified. The Product Form that is specified refers to the Product Form that is transferred from the FromNode. In step 730 a set of nodes and connections is assigned to product(s) to complete the design of a supply network.

As can be seen in FIG. 6, a scenario can include several supply chains connected in a network. In the context of the model's visual interface, a supply chain is a set of interconnected icons assigned to a set of products. Individual supply chains can be hidden or deleted from the scenario. A given scenario can also be edited dragging a connection from one node to another. Icons can be deleted as well.

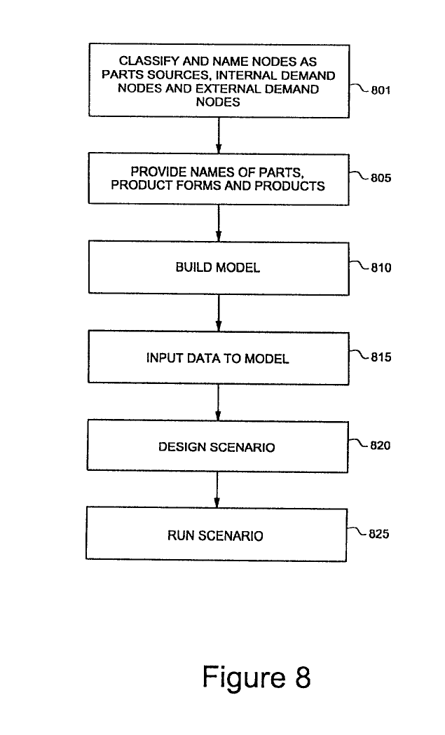

FIG. 8 shows the overall process flow for building a model and designing and running a scenario. In step 801, the nodes of the supply network are classified and named. This establishes the point in the network through which Parts and Products flow. In step 805, the names of the Product Forms and Products are provided to the Model Builder. In step 810 the model is built. At this point, the model is similar to a breadboard circuit in which the selection of components, their values and interconnects s remain to be established. In step 815 the data is input, thereby providing values required by the circuit components. In step 820, a scenario is designed by selecting a set of components and defining an interconnect scheme. Upon completion of the scenario design, a system of equations has been defined and is solved in step 825 by running the scenario.

The software is a development environment for supply chain management decision support systems. Supply Chain engineers or Supply Chain consultants can develop supply chain models on EXCEL, containing alternative supply chain designs (scenarios). By using the simulation engine provided by the invention and their own cost calculations, they can choose the best alternative, with the lowest cost and the best performance. Because of the user-friendly interface, the developed model can be used in an ongoing base as a tool for continuously managing decisions regarding the supply chain design.

Some of the advantages of the invention are:

a. Provides the framework for supply chain analysis and design

b. Makes the complicated task of supply chain design easier and more accurate.

c. Provides the algorithms and functions for a statistically based supply chain design.

d. Provides the basis for accurately predicting the cost associated with different supply chain designs, as the user desires.

e. Reduces the time that supply chain engineering groups have to spend developing the analytical models needed to support management decisions. Time is freed up for other activities like data gathering and validation.

f. Unique, and specially designed for supply chain management, user-friendly interface.

g. Based on a popular spreadsheet application (EXCEL) design.

Embodiments of the invention include:

a. A software development environment for supply chain modeling based on a solid mathematical foundation equipped with clear conventions and standardized data structures.

b. A “wizard” who builds a skeletal software application equipped with all the necessary functionality.

c. A collection of functions and routines that can be used to customize the skeletal application.

d. A user interface environment for managing the developed application. Each application consists of:

i. Alternative supply chain designs (scenarios) represented as visual presentations of the actual supply chain designs. This is a unique feature, found only in this invention.

ii. A simulation engine, which calculates product flows and activities for all products at all nodes in the supply chain.

iii. Input and output data tables.

iv. Utility and control functions.

e. A unique way to visualize a multidimensional problem in an efficient way.

The preferred embodiment of the present invention, a system and method for supply chain modeling, is thus described, While the present invention has been described in particular embodiments, it should be appreciated that the present invention should not be construed as limited by such embodiments, but rather construed according to the below claims.

1. A system for supply chain alternative scenario analysis comprising a computer system, said computer system further comprising:
a) a spreadsheet application having a macro programming capability;
b) a supply chain model builder;
c) a supply chain model; and,
d) at least one supply chain scenario.

2. The system of claim 1 wherein said model builder includes a design page that enables input of names of internal demand nodes, terminal demand node and parts sources.

3. The system of claim 2 wherein said design page further enables input of names of products, product forms and parts.

4. The system of claim 1 further including a symbolic interactive visual interface for constructing a scenario.

5. The system of claim 4 wherein said symbolic interactive visual interface includes interactive node icons and interactive connection elements.

6. The system of claim 5 wherein said interactive node icons include icons for parts sources, internal demand nodes and terminal demand nodes.

7. The system of claim 4 wherein said scenario includes more than one supply chain.

8. A method for performing alternative supply chain analysis comprising the steps of:
a) classifying and naming nodes in a supply chain;
b) classifying and naming the objects flowing through the supply chain;
c) building a supply chain model;
d) inputting data to said model; and,
e) designing at least one supply chain scenario.

9. The method of claim 8 wherein said nodes are classified as parts sources, internal demand nodes and terminal demand nodes.

10. The method of claim 8 wherein said objects flowing through the supply chain are classified as products, product forms and products.

11. The method of claim 9 wherein said supply chain scenario is designed using an interactive symbolic visual interface.

12. The method of claim 11 wherein said interactive symbolic visual interface comprises interactive node icons and interactive connection element icons.

13. The method of claim 12 wherein said interactive node icons represent parts sources, internal demand nodes and terminal demand nodes.

14. The method of claim 13 wherein the scenario properties are altered using a visual display pointing device in association with the icons.

15. A computer readable medium containing executable instructions which, when executed in a processing system, causes the system to perform the steps for analyzing alternative supply chains, comprising:
a) classifying and naming nodes in a supply chain;
b) classifying and naming the objects flowing through the supply chain;
c) building a supply chain model;
d) inputting data to said model; and,
e) designing at least one supply chain scenario.

16. The computer readable medium of claim 15 wherein the instructions for classifying and naming said nodes cause said nodes to be classified as parts sources, internal demand nodes and terminal demand nodes.

17. The computer readable medium of claim 15 wherein the instructions for classifying and naming said objects cause said objects to be classified as parts, product forms and products.

18. The computer readable medium of claim 15, further including instructions for the operation of an interactive symbolic visual interface.

19. The computer readable medium of claim 18 wherein said interactive symbolic interface comprises interactive node icons and interactive connection element icons

20. The computer readable medium of claim 19 wherein said interactive node icons represent parts sources, internal demand nodes and terminal demand nodes.
